(19) United States
(12) Patent Application Publication
(10) Pub. No.: US 2016/0081099 A1
(43) Pub. Date: Mar. 17, 2016

(54) User Equipment and a Method Therein for Channel Interference Cancellation

(71) Applicant: TELEFONAKTIEBOLAGET L M ERICSSON (PUBL), Stockholm (SE)

(72) Inventors: Sairamesh NAMMI, Kista (SE); Yi-Pin Eric WANG, Fremont, CA (US)

(73) Assignee: Telefonaktiebolaget L M Ericsson (publ), Stockholm (SE)

(21) Appl. No.: 14/784,456

(22) PCT Filed: Oct. 23, 2013
(86) PCT No.: PCT/SE2013/051229

§ 371 Date: Oct. 14, 2015

Related U.S. Application Data
(60) Provisional application No. 61/812,487, filed on Apr. 16, 2013.

(51) Int. Cl. H04W 72/08; H04W 72/04

(52) U.S. Cl. CPC H04W 72/082; H04W 72/042

(57) ABSTRACT

The embodiments herein relate to a method performed in a UE (1300) and a UE (1300) for mitigating or cancelling of interfering transmission in a network. The method comprises receiving from a network node a common control channel order comprising an information element; decoding the order; extracting an information element; reconstructing the interfering transmission and cancelling or mitigating the interfering transmission.

### TECHNICAL FIELD

The present application relates generally to a user equipment and a method therein for interference cancellation and, more specifically, to techniques of using common control channel orders to assist the user equipment to perform control-channel interference cancellation.

### BACKGROUND

During the last few years cellular operators have started to offer mobile broadband based on Wideband Code Division Multiple Access (WCDMA)/High Speed Packet Access (HSPA). Further, fuelled by new devices designed for data applications, the end user performance requirements are steadily increasing. The large uptake of mobile broadband has resulted in heavy traffic volumes. The demand on the performance and capacity of a HSPA network has grown significantly. As a result, techniques that allow cellular operators to manage their spectrum resources more efficiently are of large importance.

For example, techniques such as 4-branch MIMO, multi-flow communication, and multi carrier deployment can be used to improve downlink performance. Since improvements in spectral efficiency per link are approaching theoretical limits, next generation technologies are directed at improving spectral efficiency per unit area. For example, additional features for HSDPA are being developed to provide uniform user experience to users anywhere inside a cell by changing the topology of traditional networks. As a result, there has been an increase in deployments of different network architectures, e.g., homogenous versus heterogeneous networks, networks configured for coordinated multiple-point (CoMP) transmission and reception, etc.

Currently the third Generation Partnership Project (3GPP) standards are being enhanced to ensure uniform user experience to users located anywhere inside a heterogeneous network. See reference [1] at end of this description.

Heterogeneous and homogeneous networks are different types of networks. A homogeneous network is a network of radio network nodes (e.g. base stations, Node B, RRH, RRU etc.) in a planned layout and a collection of user terminals in which all radio network nodes (e.g. base stations) have similar transmit power levels, antenna patterns, receiver noise floors, and similar backhaul connectivity to the data network. In other words they belong to the same base station power class. For example all of them are either high power nodes (HPN) or all of them are low power nodes (LPN). An example of HPN is wide area BS serving macro cell. An example of LPN is a local area BS serving a pico cell. In other words a homogeneous network is a single tier system. Moreover, all base stations offer unrestricted access to user terminals in the network, and serve roughly the same number of user terminals. For example, current wireless system GSM, WCDMA, HASDPA, LTE, WiMax, etc. come under this category.

Compared to a homogeneous network, a heterogeneous network comprises, in addition to the planned or regular placement of HPN (e.g. macro base stations or wide area BS serving macro cell), micro/pico/femto/relay base stations as shown in FIG. 1. Therefore a heterogeneous network is a system of at least 2 tiers. Note that the power transmitted by these micro/pico/femto/relay base stations is relatively small compared to that of a macro base station. Power from a micro/pico/femto/relay base station can be up to 2 W as compared to that of 40 W for a macro base station. Generally, low power nodes (LPN) are deployed to eliminate coverage holes in homogeneous networks (using macro only). They improve the network capacity in hot-spots. Due to their lower transmit power and smaller physical size, micro/pico/femto/relay base stations can offer flexible site acquisitions.

LPNs can form a cluster of heterogeneous nodes in a heterogeneous network. LPNs can have different cell identifier than that of macro cell (different cells) or same cell identifier as that of macro cell (soft, shared, or combined cell, cluster with common cell ID).

FIG. 2 shows a heterogeneous network where LPNs are deployed to create different cells. Simulations show that using low power nodes in a macro cell offers load balancing and achieves huge gains in overall system throughout as well as cell edge user throughput. As clear from FIG. 2, cell A is a macro cell served by a macro base station, whereas cell B and cell C are LPN cells served by a respective LPN node.

One disadvantage of the above described method or scenario is that each LPN creates a different cell. As a UE moves around, soft handover is needed when it moves from the cell of one LPN to the macro cell or to the cell of another LPN. During soft handover, higher layer signaling is required.

FIG. 3 shows a heterogeneous network where low power nodes are part of the macro cell A. This is sometimes called a soft cell or a shared cell. Using soft or shared cells avoids frequent soft handovers and reduces higher layer signaling. In some embodiments, the nodes are coupled to the central node (in this case a macro node) via a high speed data link as shown in FIG. 4. In FIG. 3 a so called common pilot channel (CPICH) is depicted and this pilot is transmitted by the macro radio base station.

FIG. 4 shows the typical configuration of a combined cell deployment where the central controller in the combined cell takes responsibility for collecting operational statistics information of network environment measurements. The decision of which nodes to transmit to a specific UE is made by the central controller based on the information provided by the UE or collected on its own. The cooperation among various nodes is instructed by the central controller and implemented in a centralized way. A central controller may be one of the network nodes e.g. serving Node B, base station (BS) etc.

Even though huge gains in terms of average sector throughput are achieved with the introduction of LPNs, interference structure becomes more complex in heterogeneous networks. FIG. 5 shows the power needed to maintain a reliable transmission for a control channel, e.g., HS-SCCH, as a function of interference power in a heterogeneous network. It can be observed that as the interference becomes strong, the NodeB needs to allocate more power for the HS-SCCH transmission. For example with Type 1 receiver and an I_{oc} (interference) of 10 dB, −13 dB of additional power is needed to achieve the same performance as that of −10 dB interference.

Interference mitigation has been a useful technique in improving performance and output in any type of networks but especially heterogeneous networks. Post-decoding successive interference cancellation is a well-known method for improving a network's capacity. However, prior art has focused on cancelling interference from data channels. There is a need for interference cancellation techniques that can mitigate control channel interference.

### SUMMARY

An object of embodiments herein is to provide a user equipment (UE) and a method therein for mitigating/cancelling of interfering transmission in a network comprising at least one network node thereby improving the performance of downlink control channels.

According to an aspect of embodiments herein, the object is achieved by providing a method performed in a UE for mitigating/cancelling of interfering transmission in a network comprising at least one network node, the method comprising: receiving, from the network node, a common control channel order comprising an one or more information elements; decoding the common control channel order and extracting at least one of said one or more information elements; reconstructing the interfering transmission, and cancelling/mitigating the interfering transmission.

According to another aspect of embodiments herein, the object is achieved by providing a UE for mitigating/cancelling of interfering transmission in a network comprising at least one network node. The UE comprising: a transceiver and an antenna system configured to receive, from the network node, a common control channel order comprising one or more information elements; the UE further comprising one or more processing circuits configured to decode the common control channel and to extract the one or more information elements. The one or more processing circuits is further configured to reconstruct the interfering transmission, and the one or more processing circuits is further configured to cancel/mitigate the interfering transmission.

An advantage with the embodiments herein is to improve the performance of downlink control channel reception in a network e.g. a HSPA network.

Another advantage with the embodiments herein is to improve the link throughput of the UE.

Of course, the present embodiments are not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 illustrates an exemplary deployment of a heterogeneous network.

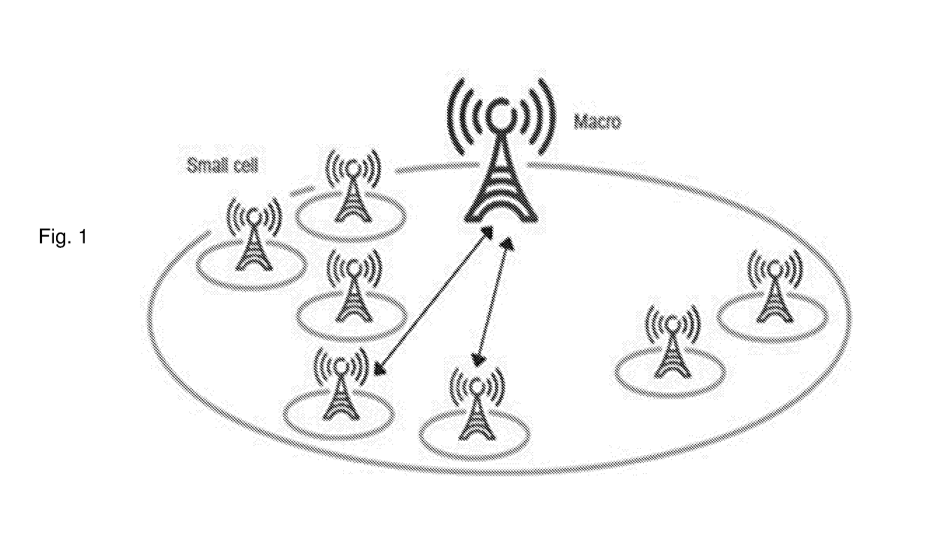

FIG. 2 illustrates an exemplary heterogeneous network comprising low power nodes of different cell ids.

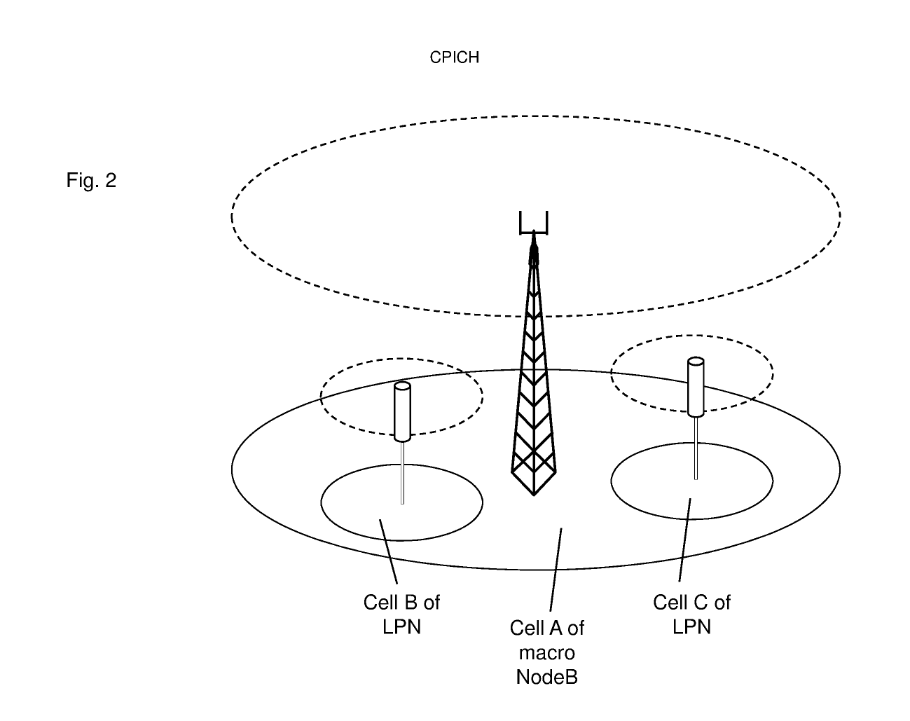

FIG. 3 illustrates an exemplary heterogeneous network comprising low power nodes using the same cell id as the macro node.

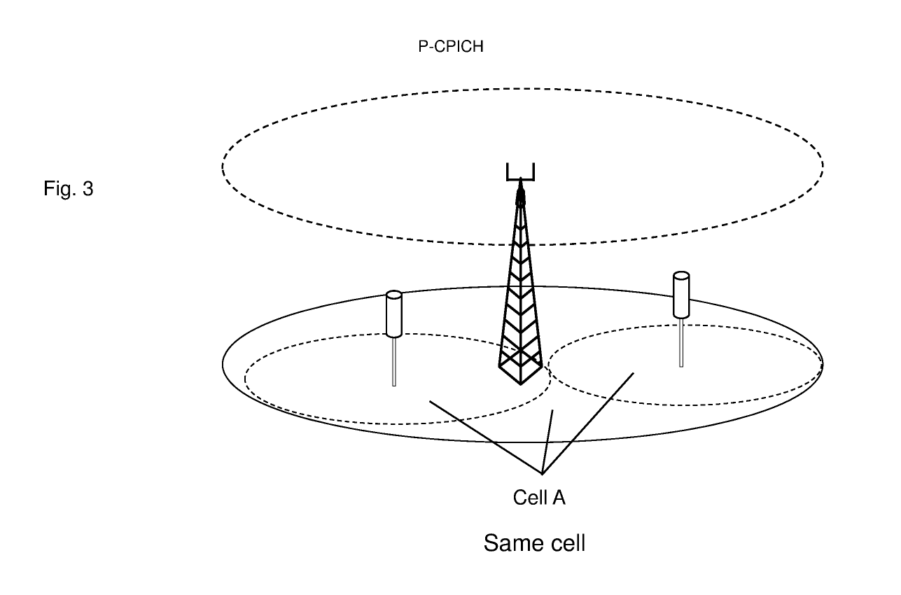

FIG. 4 illustrates an exemplary deployment of a combined cell.

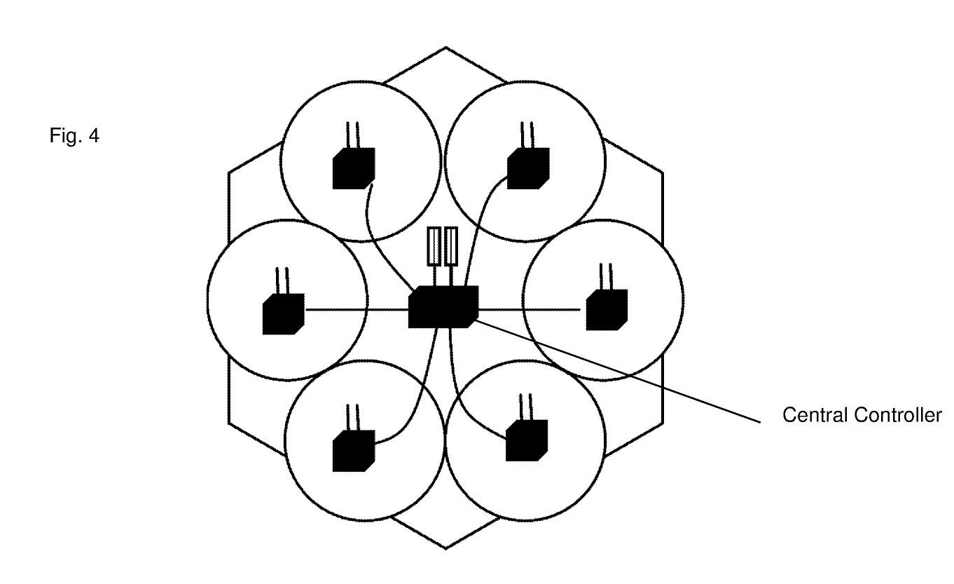

FIG. 5 is a chart depicting HS-SCCH performance in a heterogeneous network.

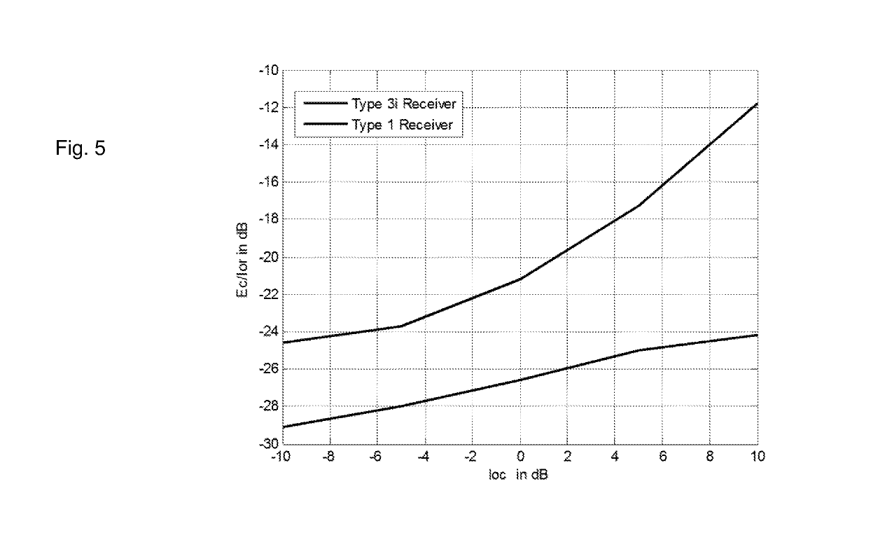

FIG. 6 illustrates an exemplary message flow between network nodes and a UE.

FIG. 7 illustrates a timing shift between a control channel HS-SCCH and a data channel HS-PDSCH.

FIG. 8 is a flow chart illustrating a process implemented on a network node to provide network assistance for control channel interference cancellation.

FIG. 9 illustrates an exemplary network node configured to provide network assistance to UEs in support of control channel interference cancellation.

FIG. 10 is a flow chart illustrating main steps of a method or process implemented on UE for cancelling interference in accordance with embodiments herein.

FIG. 11 is a flow chart illustrating an interference cancellation process implemented on a UE in accordance with an exemplary embodiment.

FIG. 12 is another flow chart illustrating an interference cancellation process implemented on a UE in accordance with another exemplary embodiment.

FIG. 13 illustrates a block diagram of an exemplary UE configured for interference cancellation in accordance with embodiments herein.

### DETAILED DESCRIPTION

In the following, a detailed description of the exemplary embodiments of the present invention is described in conjunction with the drawings, in several scenarios to enable easier understanding the solution(s) described herein.

Throughout this disclosure, the word “comprise” or “comprising” has been used in a non-limiting sense, i.e. meaning “consist at least of”. Although specific terms may be employed herein, they are used in a generic and descriptive sense only and not for purposes of limitation. In particular, it should be noted that although terminology from 3GPP HSPA has been used in this disclosure to exemplify the embodiments herein, this should not be seen as limiting the scope of the invention to only the aforementioned system. Other wireless systems, including LTE, LTE-A (or LTE-Advanced), UMTS, WiMax, and wireless LAN, may also benefit from exploiting the ideas covered within this disclosure.

Furthermore, embodiments herein may be realized in many ways. As previously described embodiments herein relate to a method in a UE and a UE for cancelling or mitigating interference from interfering transmission by making use of network assisted information transmitted from a network node. An additional way to realize the embodiments herein is to provide a computer program in the form of instructions stored in the UE. The instructions executable by the UE and stored on a computer-readable medium perform the method as will be described and also as presented in the pending claims relating to the method performed by UE. As will be described, embodiments herein also relate to a UE include hardware as presented in the pending claims relating to the UE. It should be emphasized that the UE is not restricted to hardware elements indicated in the claims. Various “circuits” and “units” of the E described may refer to a combination of analog and digital circuits, and/or one or more processors configured with software and/or firmware (e.g., stored in memory) that, when executed by the one or more processors, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

As previously described embodiments herein relate to a method in a UE and a UE for cancelling or mitigating interference from interfering transmission by making use of network assisted information transmitted from a network node. The network assisted information include is some embodiments a common control channel order, e.g. a common HS-SCCH order for e.g. HSDPA or HSPA, although not restricted to HSDPA or HSPA. The HS-SCCH order is transmitted from the network node to the UE and this allows the network to send the order to a single UE or to a group of UEs in the network. In other words, in some embodiments, a method of conveying the scheduling information using common HS-SCCH order is introduced to provide network assistance for downlink data transmission via e.g., HS-PDSCH, where the network sends information about the scheduling information or the UE ID of the interferer to the victim UE.

In the following sections, a HS-SCCH is used as an example to illustrate the advantageous techniques disclosed herein. However, the same methods and approaches are applicable to other downlink signaling channels, e.g., E-AGCH, E-RGCH, E-HIGH, etc.

A network node e.g. a NodeB or a eNB or any suitable network node provides assistance to the UE to improve the performance of downlink control channel. The assistance is provided in the HS-SCCH as explained above in case of HSDPA or HSPA. A Common HS-SCCH orders may be used to convey scheduling information to all UEs. Common HS-SCCH orders allow a single HS-SCCH order to address multiple UEs. This provides means for sending control commands to many UEs without sending as many HS-SCCH orders. A new type of common H-RNTI is defined for common HS-SCCH orders. This high speed downlink shared channel radio network temporary identity (H-RNTI) is shared by a group of UEs and signaled to all of them. It should be noted that a H-RNTI may also be dedicated to a single UE in order for the UE to be identified. See 3GPP Release 12 UE. The H-RNTI is an example of an information element.

An HS-SCCH order is scrambled with a cell-specific downlink scrambling code in the same way as defined in 3GPP specifications. HS-SCCH orders from a particular cell are intended for UEs served by that cell. However, a UE can monitor HS-SCCH channels for orders from its serving cell(s) and HS-SCCH channels from neighboring cells. In existing 3GPP specifications, UEs monitor a number of HS-SCCH channels in the serving HS-DSCH cell and in any activated secondary serving HS-DSCH cells and up to one HS-SCCH channel in a non-serving cell e.g. for triggering of enhanced serving cell change.

When a UE receives a UE-specific HS-SCCH order, the order is acknowledged by the UE with an ACKnowledgment ACK codeword in the Hybrid Automatic Repeat request—ACK (HARQ-ACK) field on a HS-DPCCH channel. The UE generally does not send a NACK in response to an HS-SCCH order. If the UE does not ACK the order, the NodeB may choose to retransmit the order, possibly with a higher transmit power, until an ACK is received from the UE or until a maximum number of retransmissions have been reached.

For common HS-SCCH orders, the network can monitor HARQ-ACK from all UEs in the group. In case one or several UE do not ACK the order, the network may choose to either retransmit the order using a common order, or retransmit the order only to users that have not ACKed the order. Each UE may, in the general case, only transmit either one ACK or one NACK (or not transmit anything at all, i.e. DTX) in the HARQ-ACK field on HS-DPCCH at a given point in time. This means that it may not be, in the general case, possible for the UE to acknowledge both a UE-specific HS-SCCH order and a common HS-SCCH order at the same time. The NodeB may avoid potential ambiguities by avoiding transmitting UE-specific and common HS-SCCH orders simultaneously to a UE.

According to embodiments of the present invention (common) HS-SCCH order(s) is/are used for interference cancellation. In such embodiments, the UE may not need to send an ACK/NAK. This is because the ACK/NACK usually needs to be sent dynamically. When a UE receives a common HS-SCCH, there is a delay involved with sending ACK/NAK before the order is applied. The UE may utilize common HS-SCCH orders to improve downlink control channel reception.

According to embodiments herein, a HS-SCCH order or, a common HS-SCCH order may be used to send the configuration information (transport format, modulation and coding scheme, etc.) about a scheduled interfering HS-PDSCH data transmission. A victim UE, which may be suffering from said interference, upon receiving the common HS-SCCH order, is configured to extract the configuration information from the HS-SCCH order in order to decode the interfering data transmission to achieve interference cancellation. Because there is always a HS-SCCH transmission associated with the HS-PDSCH data transmission to inform a scheduled UE of the scheduled data transmission, cancelling the interference caused by the HS-SCCH transmission improves downlink reception. In some embodiments, a common HS-SCCH order contains one or more information elements such as a UE IDentification (ID) scheduled during a Transmission Time Interval (TTI) and a transmission mode to be used, for instance, non MIMO mode, MIMO mode, MIMO mode with single stream restriction, or MIMO mode with four transmit antennas. The UE or UEs may therefore take advantages of (common) HS-SCCH order to improve downlink control channel reception. The network node or UE causing the interfering is here denoted an aggressor network node (e.g. a base station (BS) or NodeB) or an aggressor UE respectively.

A victim UE, which is experiencing interference from an aggressor base station (BS) or NodeB, may use the (common) HS-SCCH order containing the information about a scheduled transmission from the aggressor BS serving a scheduled UE to reduce control channel interference. The scheduled transmission is often referred as interfering transmission in this context of the present disclosure. The UE served by the aggressor BS is also referred to as the scheduled UE. As mentioned above, the information contained in the common HS-SCCH order may include a UE ID of the scheduled UE and/or the transmission mode to be used in the scheduled transmission. The scheduled UE may be located in the same cell or in a neighbour cell i.e. a cell neighbouring the cell where the victim UE is currently located. If both the aggressor UE and the victim UE are in the same cell, the aggressor BS is the serving BS of the victim UE.

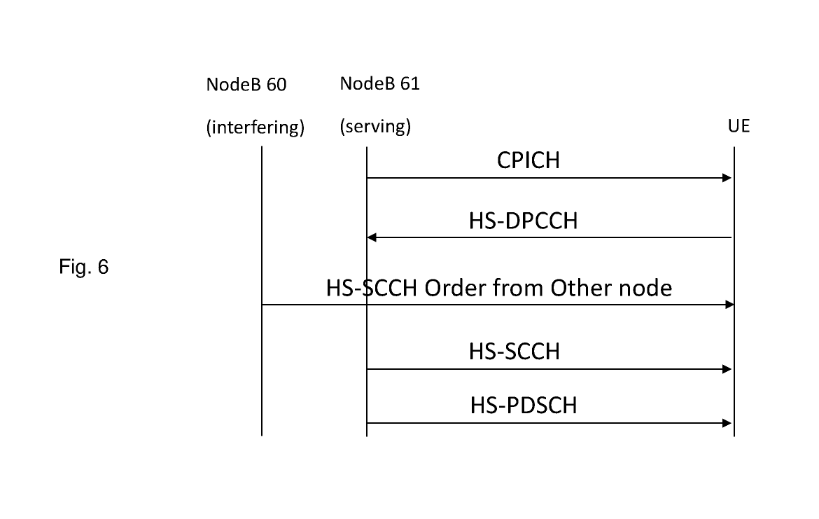

As an example, FIG. 6 shows an exemplary message flow between network nodes and a victim UE. The victim UE is shown receiving a (common) HS-SCCH order from an interfering cell which is served by the interfering Node B 60. A serving Node B serving 61 the victim UE is also depicted. The serving Node B 60 and the interfering Node B 60 may be the same node or different nodes. When the serving and interfering Node Bs 60, 61 are the same node, the interfering cell coincides with the serving cell of the victim UE. Messages are exchanged between the Node Bs and the victim UE during e.g. a data call set up in e.g. HSDPA. From the common pilot channel (CPICH) transmitter by Node B 61, the UE estimates the channel and computes the channel quality information (CQI) and precoding indicator (PI). This information along with hybrid ARQ ACK/NAK is reported to the serving Node B using dedicated physical control channel (HS-DPCCH). The minimum periodicity of HS-DPPCH is one subframe (2 msec). The Node B 61 scheduler determines the parameters like modulation and code rate (Transport block (TB) size), precoding index, rank information (RI) for the data transmission (HS-PDSCH), which are sent through the HS-SCCH channel. After HS-SCCH, the data channel HS-PDSCH is transmitted. In FIG. 6, before the HS-SCCH signal is transmitted, the UE also receives a S-SCCH order from the aggressor Node B 60 informing about a schedule transmission of an interfering UE served by the aggressor Node B 60. The (common) HS-SCCH order contains the interfering UE's ID and the transmission mode to be used in the scheduled transmission.

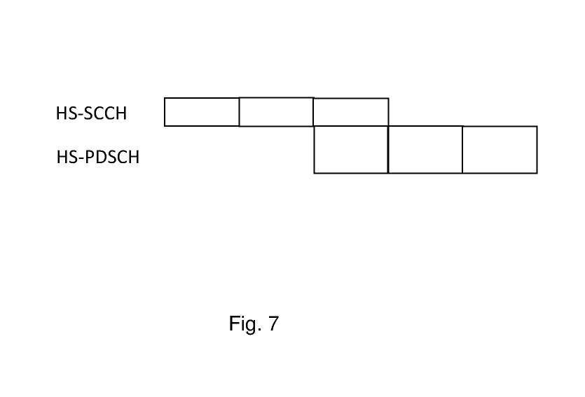

The HS-SCCH signal may be used to inform the UE of the scheduling information about a scheduled downlink transmission to that UE. Scheduling information includes rank, modulation, channelization codes to be used in the downlink transmission. Scheduling information is transmitted via a HS-SCCH channel and the downlink transmission is transmitted via a data channel, e.g., the HS-PDSCH channel. The HS-SCCH is staggered with HS-PDSCH as shown in FIG. 7, where the HS-SCCH is sent in 2 slots ahead of HS-PDSCH.

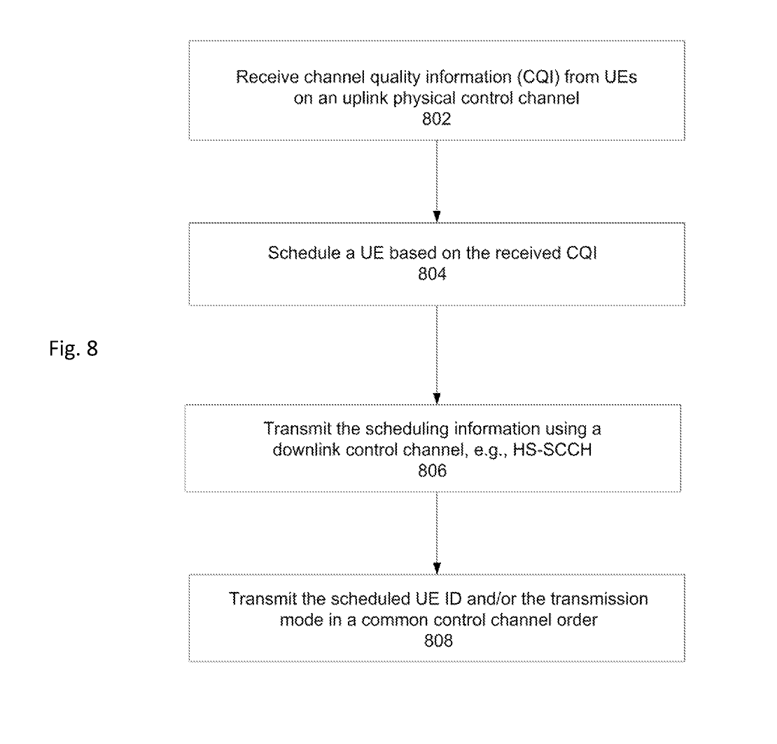

FIG. 8 is a flow chart illustrating an exemplary process implemented on a network node for providing network assistance to control channel interference cancellation. In FIG. 8, the network node e.g. NodeB receives channel quality information (CQI) from the UEs served by the network node (step 802). The CQI is received on an uplink physical channel, e.g., HS-PDSCH. The network node schedules a UE for downlink transmission based on the received CQI (step 804). The scheduling information is transmitted using a downlink control channel, e.g., HS-SCCH (step 806). The network node also transmits a common control channel order to transmit the scheduled UE ID and/or the transmission mode of the scheduled transmission.

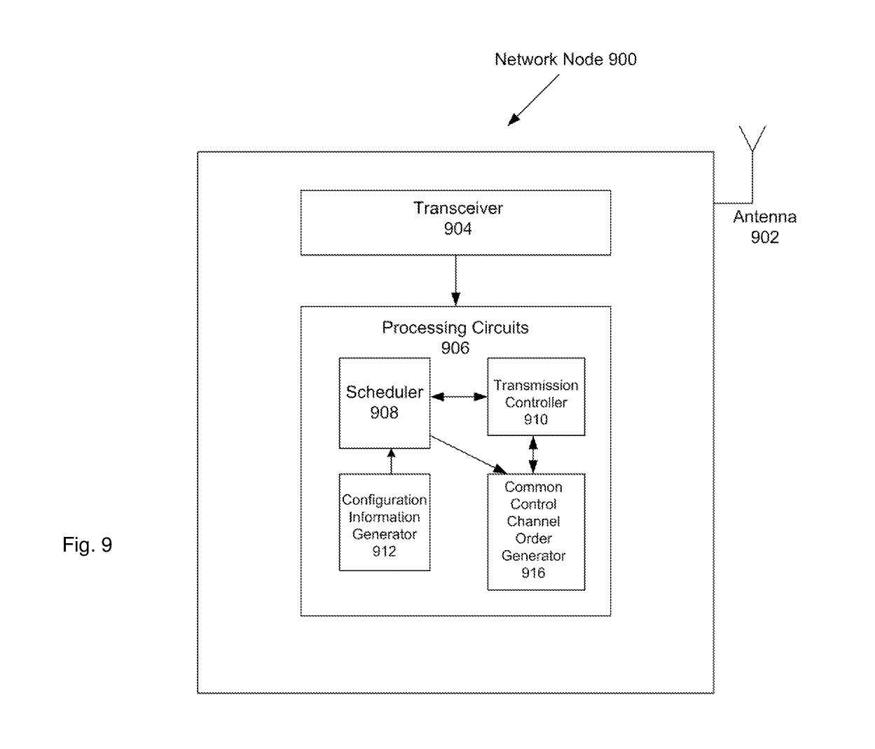

FIG. 9 depicts an exemplary network node 900 configured to assist UEs in control channel interference cancellation. The network node 900 comprises an antenna system 902, a transceiver 904, and processing circuits 906. The antenna system 902 is configured to transmit and receive signals to and from UEs. The transceiver 904 comprises circuits for up-converting or down-converting signals and circuits for converting analogue signals to digital signals and vice versa (not shown). The processing circuits 906 comprise a configuration information generator 912, a schedule 908, a transmission controller 910, and a common control channel order generator. The configuration information generator is used to provide the scheduler 908 the necessary configuration information needed to schedule a transmission, for example, transport format (TF) and modulation and coding scheme (MCS) to be used in the scheduled transmission. The schedule 908 schedules transmissions for UEs based on received CQI information. The scheduling information is provided to the common control channel order generator 916 to generate a common control channel order comprising information of a scheduled transmission, for example, the UE ID of the scheduled UE and the transmission mode. The scheduling information is also provided to the transmission controller 910, which controls the transmission of the scheduling information, the scheduled data transmission, and the common control channel order transmission.

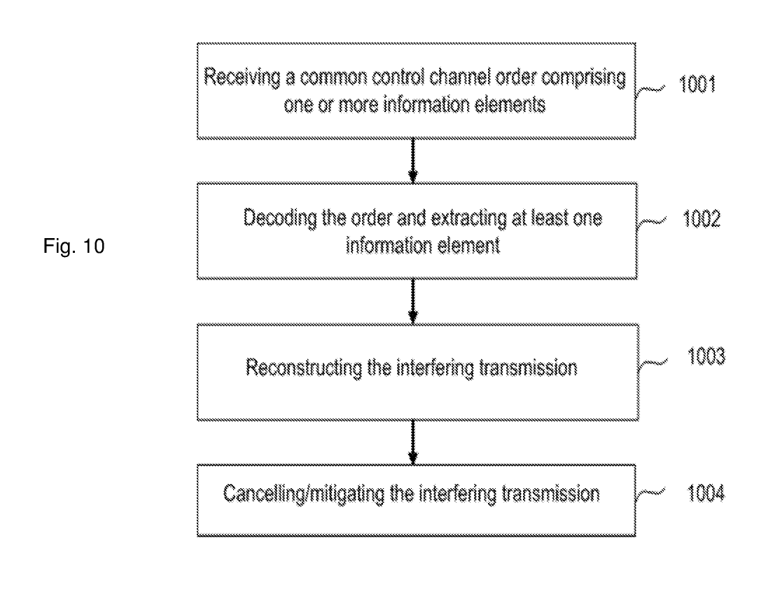

The common control channel orders generated by the common control channel order generator 916 are used by a victim UE to perform interference cancellation. FIG. 10 is a flowchart illustrating the main steps of a method or process implemented in/on a UE for cancelling/mitigating interference according with embodiments herein. In this context, this UE is referred to as a victim UE. As shown the method comprises:
(1001) receiving, from the network node, a common control channel order comprising an one or more information elements;
(1002) decoding the common control channel order and extracting at least one of said one or more information elements;
(1003) reconstructing the interfering transmission, and
(1004) cancelling/mitigating the interfering transmission.

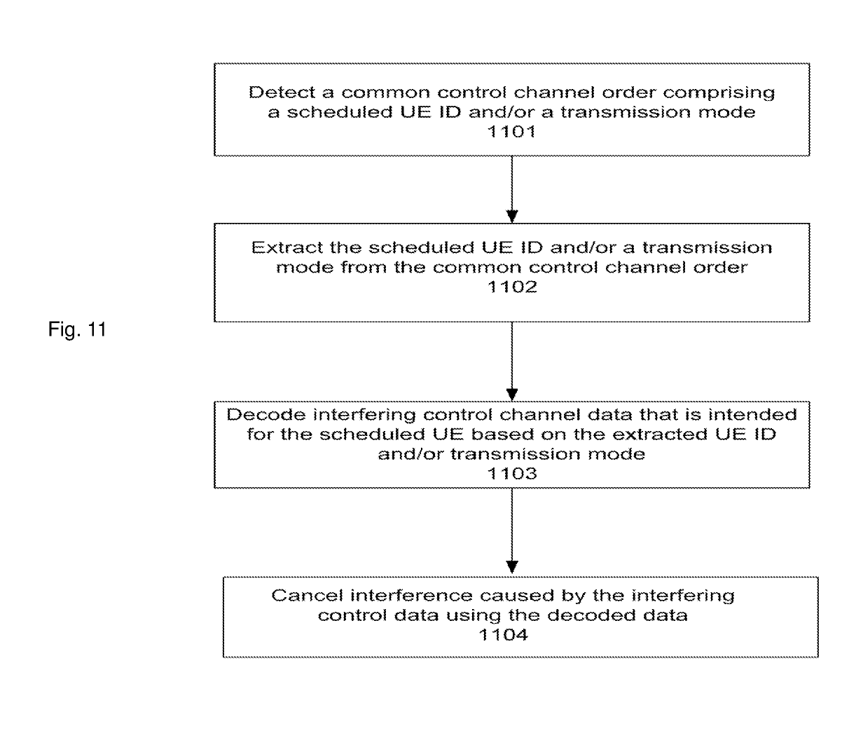

Upon receiving a common HS-SCCH order from a network node e.g. a neighbour node, neighbouring the network node serving the UE, the victim UE may use an information element e.g. a UE ID of the scheduled UE and/or the transmission mode included in the common control channel order to cancel control channel interference. An exemplary procedure is described below in reference to FIG. 11.

Step 1101: The victim UE detects the common HS-SCCH order comprising a scheduled UE ID and tries to decode the HS-SCCH order and extracts the UE identifier (ID) sent by the network node and also the transmission mode.

Step 1102: the UE extracts the scheduled UE ID and/or the transmission mode from the order.

Step 1103: Once the transmission mode and/or the UE ID is known, the UE will try to decode the corresponding HS-SCCH of the interfering UE. Hence the UE decodes the interfering control channel data that is intended for the scheduled UE based on the extracted UE ID and/or transmission mode. Both UE ID and transmission modes are examples of an information element. Then, the HS-SCCH of the interfering UE is reconstructed.

Step 1104: The UE then cancels the interference caused by the interfering transmission e.g. the interfering control data. Cancellation may be performed using the decoded control data e.g. the HS-SCCH.

Hence, from a received signal the reconstructed HS-SCCH is removed. The received signal may refer to a composite signal comprising of all physical code-division multiplexed signals from all Node B's. According to an exemplary embodiment, the UE may further decode the own HS-SCCH using its own UE ID., and further reconstruct the interferer HS-PDSCH and remove the interference from the received signal.

Here HS-SCCH reception is used as an example. The benefit of cancelling the interfering UE's HS-SCCH and HS-PDSCH can be applied to the reception of other downlink signalling channels, e.g. a Enhanced Absolute Grant Channel, E-AGCH, transmission or a Enhanced Relative Grant Channel, E-RGCH, transmission or a Enhanced HARQ Acknowledgement Indicator, E-HICH, transmission, transmitted by the network node to scheduled UE. Also, the common HS-SCCH order itself can be cancelled as well. Thus in the case after step 1, and before step 2, steps 1a and 1b may be added (not shown in FIG. 11).

Step 1a: Reconstruct the received signal of the HS-SCCH order.

Step 1b: From the received signal the reconstructed HS-SCCH order is removed.

By using common HS-SCCH orders which convey information about scheduling information of other interfering nodes, the HS-SCCH performance (or the performance of any DL control channel) is improved, thereby the probability of success of HS-PDSCH is improved. Hence the link throughput for the UEs may be significantly improved in interference limited scenarios.

The same methods and techniques may be used to improve the performance of any downlink channel. In some embodiments, the control channel data, decoded and reconstructed using a UE ID of the scheduled UE, may be used to cancel interference on a downlink channel other than the HS-SCCH channel and improve downlink performance of any DL control or data channel.

Similarly, using the configuration information of a scheduled data transmission broadcast in a common HS-SCCH order, the data transmission may be decoded and reconstructed from, for example, a HS-PDSCH transmission. The decoded and reconstructed data transmission may be removed from a received signal to cancel interference. The received signal may be a control channel data signal, a data signal, or a composite signal. Hence according to an exemplary embodiment, the method performed in/on a UE comprises reconstructing an interfering high-speed physical data shared channel; HS-PDSCH, transmitted from the network node and removing interference from the interfering HS-PDSCH.

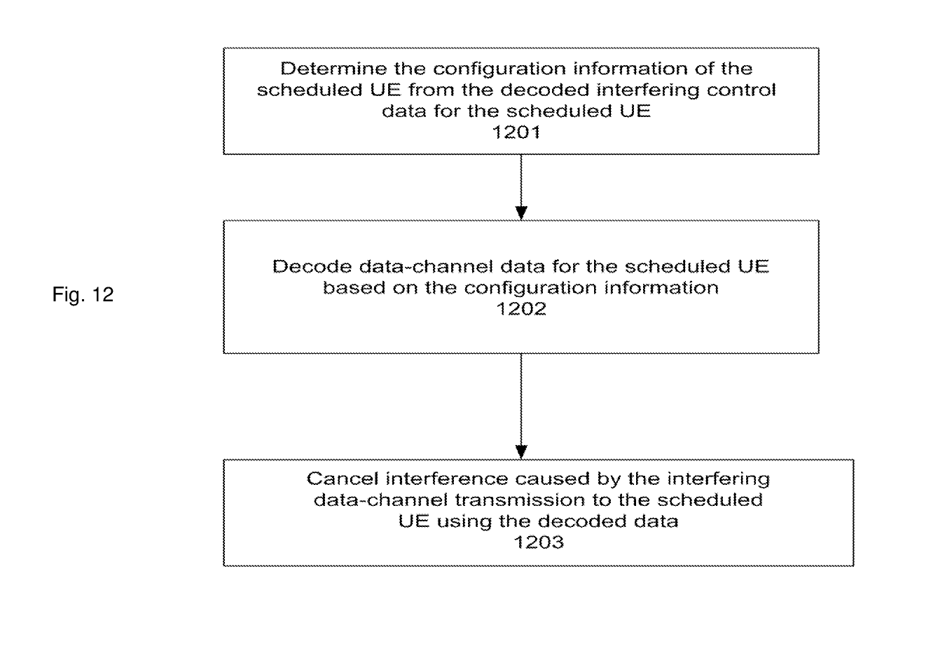

FIG. 12 illustrates another exemplary interference cancellation process, performed by the UE, in which interfering data channel transmissions are decoded for interference cancellation.

In FIG. 12, the victim UE determines the configuration information of the scheduled UE data transmission from or using the decoded interfering control channel data for the scheduled UE (see step 1201). The configuration information is then used by the victim UE to decode the scheduled data transmission that is causing interference on the victim UE (see step 1202). The decoded interfering data transmission may be removed from a received signal to cancel interference caused by the interfering data-channel transmission to the scheduled UE (1203).

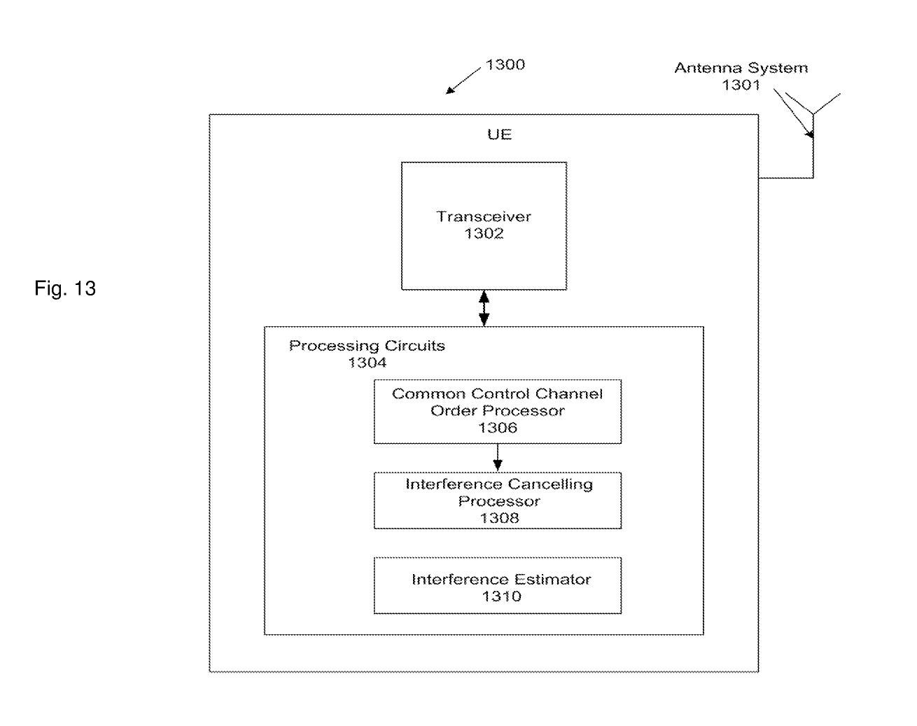

Referring to FIG. 13 there is illustrated a block diagram of an exemplary UE 1300 configured to support the above described interference cancellation/mitigation processes. The UE is configured to cancel/mitigate an interfering transmission in a network comprising a network node as previously described. The UE 1300 comprises an antenna system 1301, a transceiver 1303, and processing circuits 1304. The transceiver may be a combination of a transmitter and a received in integrated form. However, a transceiver may also be a combination or a received and a transmitter separated from each other and interconnected. The antenna system 1301 and the transceiver 1302 are configured to communicate with network nodes using radio frequency signals. The processing circuits 1304 comprise a common control channel order processor 1306, an interference cancelling processor 1308, and an interference estimator 1310. The common control channel order processor 1306 is configured to process, for example, to extract a scheduled UE ID and/or transmission mode, a received common control channel order. The interference cancelling processor 1308 is configured to use the information extracted from the common control channel order to remove interfering transmissions to achieve interference cancellation. The interference estimator 1310 is configured to estimate CQI to aid a network node in downlink transmission scheduling.

Hence, the transceiver 1303 and an antenna system 1301 are configured to receive, from the network node, a common control channel order comprising one or more information elements. The one or more processing circuits 1304 is/are configured to decode the common control channel order and extracting at least one of said one or more information elements. The one or more processing circuits is/are further configured to reconstruct the interfering transmission, and is/are further configured to cancel/mitigate the interfering transmission.

As previously described, the received common control channel order is a high speed shared control channel (HS-SCCH) order and wherein said one or more information elements comprise one or more of: a UE ID (e.g. H-RNTI) of a scheduled UE receiving said interfering transmission from the network node; and a transmission mode of the interfering transmission.

The interfering transmission may be an interfering high-speed physical data shared channel (HS-PDSCH) transmitted from the network node and the one or more circuits is/are configured to remove interference from the interfering HS-PDSCH. Further the H-RNTI identifying the scheduled UE; and the own identity of the UE is a H-RNTI identifying the UE.

As clear from the detailed description above, several advantages are achieved by the embodiments described herein. For example, an advantage with the embodiments herein is to improve the performance of downlink control channel reception in a network e.g. a HSPA network.

Another advantage with the embodiments herein is to improve the link throughput of the UE.

It should be noted that the UE may further comprise a memory for storing information and that the embodiments herein may be implemented through the one or more processors or processing units e.g. processing circuit or unit of the UE together with a computer program code for performing the functions and/or method steps of the embodiments. The program code mentioned above may also be provided as a computer program product, for instance in the form of a data carrier carrying computer program code for performing embodiments herein when being loaded into the network node. One such carrier may be in the form of a CD ROM disc. It is however feasible with other data carriers such as a memory stick. The computer program code may furthermore be provided as pure program code on a server and downloaded to the network node.

Additional details on the method steps and functions performed by the UE have already been described in greater detail and therefore a repetition of the previous text is not considered necessary.

Those skilled in the art will also appreciate that the various “circuits” described may refer to a combination of analog and digital circuits, and/or one or more processors configured with software and/or firmware (e.g., stored in memory) that, when executed by the one or more processors, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Throughout this disclosure, the word “comprise” or “comprising” has been used in a non-limiting sense, i.e. meaning “consist at least of”. Although specific terms may be employed herein, they are used in a generic and descriptive sense only and not for purposes of limitation

### ABBREVIATIONS

MIMO Multiple input multiple output
HSDPA High Speed Downlink Packet Access
HSPA High Speed Packet Access
HS-SCCH High speed shared control channel
HS-PDSCH High speed Physical data shared channel
HARQ Hybrid automatic repeat request
UE User Equipment
TTI Transmit Time Interval
PCI Precoding control index
Tx Transmitter
LPN Low Power Node
L1 Layer 1
RRU Remote Radio Unit
RNC Radio Network Controller
DL Downlink
WCDMA Wideband Code Division Multiple Access
3GPP 3rd Generation Partnership Project
CPICH Common Pilot Channel
GSM Global System for Mobile (Communication)
LTE Long Term Evolution

### REFERENCES

The content of the following reference are incorporated by reference in its entirety.
[1] RP-121436, Study on UMTS Heterogeneous Networks

1-10. (canceled)

11. A method performed in a user equipment (UE) for cancelling of an interfering transmission in a network, the network comprising at least one network node, the method comprising:
receiving, from the network node, a common control channel order comprising an one or more information elements;
decoding the common control channel order;
extracting at least one of said one or more information elements;
reconstructing the interfering transmission; and
cancelling the interfering transmission.

12. The method of claim 11, further comprising:
reconstructing an interfering high-speed physical data shared channel (HS-PDSCH) transmitted from the network node; and
removing interference from the interfering HS-PDSCH.

13. The method of claim 11, wherein:
receiving a common control channel order comprises receiving a high speed shared control channel (HS-SCCH) order; and
wherein the one or more information elements comprise at least one of:
an identity (UE ID) of a scheduled UE receiving the interfering transmission from the network node; and
a transmission mode of the interfering transmission.

14. The method of claim 13, wherein:
the UE ID is a high speed downlink shared channel radio network temporary identity (H-RNTI) identifying the scheduled UE; and
an own identity of the UE is a H-RNTI identifying the UE.

15. The method of claim 13, wherein the interfering transmission is a HS-SCCH transmission transmitted by the network node to the scheduled UE, or an Enhanced Absolute Grant Channel (E-AGCH) transmission transmitted by the network node to the scheduled UE, or an Enhanced Relative Grant Channel (E-RGCH) transmission transmitted by the network node to the scheduled UE, or an Enhanced Hybrid Automatic Repeat Request Acknowledgement Indicator (E-HICH) transmission transmitted by the network node to the scheduled UE.

16. A user equipment (UE) for cancelling of an interfering transmission in a network, the network comprising at least one network node, the UE comprising:
a transceiver and an antenna system configured to receive, from the network node, a common control channel order comprising one or more information elements;
one or more processing circuits configured to:
decode the common control channel order; and
extract at least one of the one or more information elements;
reconstruct the interfering transmission;
cancel the interfering transmission.

17. The user equipment of claim 16, wherein:
the interfering transmission is an interfering high-speed physical data shared channel (HS-PDSCH) transmitted from the network node;
the one or more processing circuits are configured to remove interference from the interfering HS-PDSCH.

18. The user equipment of claim 16, wherein:
the received common control channel order is a high speed shared control channel (HS-SCCH) order; and
the one or more information elements comprise one or more of:
an identity (UE ID) of a scheduled UE receiving the interfering transmission from the network node; and
a transmission mode of the interfering transmission.

19. The user equipment of claim 18, wherein:
the UE ID is a high speed downlink shared channel radio network temporary identity (H-RNTI) identifying the scheduled UE;
an own identity of the UE is a H-RNTI identifying the UE.

20. The user equipment of claim 16, wherein the interfering transmission is a HS-SCCH transmission transmitted by the network node to scheduled UE, or an Enhanced Absolute Grant Channel (E-AGCH) transmission transmitted by the network node to the scheduled UE, or an Enhanced Relative Grant Channel (E-RGCH) transmission transmitted by the network node to the scheduled UE, or an Enhanced Hybrid Automatic Repeat Request Acknowledgement Indicator (E-HICH) transmission transmitted by the network node to the scheduled UE.
